(19) United States
(12) Patent Application Publication
(10) Pub. No.: US 2025/0134127 A1
(43) Pub. Date: May 1, 2025

(54) DOUBLE-FILLING PINEAPPLE DAIFUKU

(71) Applicant: SAN SHU GONG FOOD CO., LTD., New Taipei City (TW)

(72) Inventor: Mei-Yao Chen, New Taipei City (TW)

(21) Appl. No.: 18/498,065

(22) Filed: Oct. 31, 2023

(51) Int. Cl. A23G 3/48; A23G 3/54

(52) U.S. Cl. CPC A23G 3/48; A23G 3/54

(57) ABSTRACT

A double-filling pineapple daifuku mainly includes, in sequence from center to outside, a first internal layer, a second internal layer enclosing the first internal layer, and an external layer enclosing the second internal layer. The first internal layer includes a pineapple filling that includes, in a part thereof, fruit pulp and is of a sticky form. The second internal layer includes a vegetable/fruit filling made of banana, mango, coconut, or taro. The external layer includes mochi formed of a soft sticky rice-based material. The external layer is wrapped, with a predetermined thickness, around the second internal layer, so that the double-filling pineapple daifuku exhibits multiple flavors. The pineapple filling of the first internal layer and the vegetable/fruit filling of the second internal layer create a soft and loose multilayered mouthfeel, presenting a new flavor of double fillings to thereby enhance a product value of mochi.

### BACKGROUND OF THE INVENTION

### (a) Technical Field of the Invention

The present invention relates to a double-filling pineapple daifuku, and more particularly to a double-filling pineapple daifuku, which, when eaten, creates soft and loose multilayered mouthfeel, and presents a new dual-stuffing taste.

### (b) Description of the Prior Art

Pineapple cakes recently catch the attention of general consumers and are now a popular souvenir or present. As shown in FIG. 4, a commonly available pineapple cake 1 is generally composed of a filling 11 and an outer pastry skin 12 the encloses the filling 11. The outer pastry skin 12 is made of low-gluten flour mixed with egg liquid, butter, and sugar and subsequently baked to have the filling 11 completely enclosed in the outer pastry skin 12. The traditional filling 11 of the pineapple cake 1 is generally pineapple jam or winter melon jam, so that, as being combined with the baked outer pastry skin 12, in addition to a soft and loose mouthfeel perceived when eaten, presents a sour and sweet taste with the filling.

For all brands, the known pineapple cake presents, in respect of mouthfeel, puffiness from the outer pastry skin 11 and softness from the filling 11 and has generally two flavors of tart and sweet. As such, the flavors of pineapples 1 produced by all bakery are generally identical and showing no variety, providing the general consumers with no sense of novelty, and therefore, they may not attract consumers who do not love the traditional flavors. Further, due to the reasons of being long consistent of the flavor and having no variety, the general consumers are given no much choice and as such, product competition power is affected.

In view of the above, the present invention aims to provide a double-filling pineapple daifuku, which presents a new taste of dual fillings, in order to enhance the sense of novelty for the pineapple daifuku and also to provide the pineapple daifuku with a multilayer varying taste as compared with the traditional pineapple cakes.

### SUMMARY OF THE INVENTION

The primary objective of the present invention is to provide a double-filling pineapple daifuku, in which a pineapple filling and a vegetable/fruit stuffing filling of internal layers and mochi of an external layer jointly create a soft and loose multilayered mouthfeel, presenting a new flavor of double fillings, providing the pineapple daifuku with a better layer varying mouthfeel as compared with the known pineapple cakes to thereby improve product competition power.

The double-filling pineapple daifuku comprises, in sequence from center to outside, a first internal layer, a second internal layer enclosing the first internal layer, and an external layer enclosing the second internal layer. The first internal layer comprises a pineapple filling; the second internal layer comprises a vegetable/fruit filling; and the external layer comprises mochi formed of a soft sticky rice-based material, wherein the external layer is wrapped, with a predetermined thickness, around the second internal layer, so that the double-filling pineapple daifuku exhibits multiple flavors. The pineapple filling of the first internal layer is combined with the vegetable/fruit filling of the second internal layer such that when the double-filling pineapple daifuku is being eaten, the pineapple filling of the first internal layer and the vegetable/fruit filling of the second internal layer that encloses the first internal layer create a soft and loose multilayered mouthfeel, presenting a new flavor of double fillings to thereby enhance a product value of mochi.

In the double-filling pineapple daifuku, the first internal layer comprises a pineapple filling that includes, in a part thereof, fruit pulp and is of a sticky form.

In the double-filling pineapple daifuku, the second internal layer comprises a vegetable/fruit filling made of banana, mango, coconut, or taro.

### BRIEF DESCRIPTION OF THE DRAWINGS

FIG. 1 is a perspective view of the present invention.

FIG. 2 is a cross-sectional view of the present invention.

FIG. 3 is a schematic view showing the present invention in a condition of being eaten.

FIG. 4 is a schematic view, partly sectioned, showing a known pineapple cake.

### DETAILED DESCRIPTION OF THE PREFERRED EMBODIMENTS

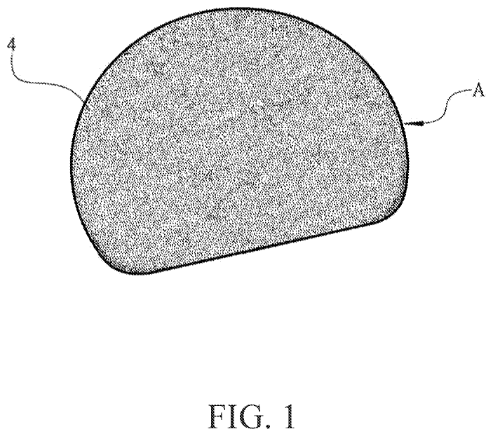

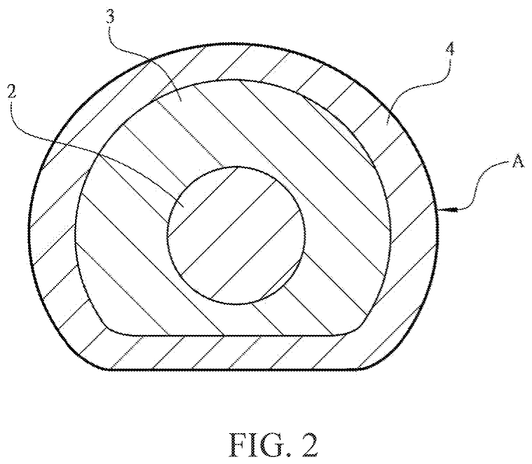

Referring jointly to FIGS. 1 and 2, which are respectively a perspective view and a cross-sectional view of the present invention, as shown in the drawings, the present invention includes, in sequence from center toward outside, a first internal layer 2, a second internal layer 3 enclosing the first internal layer 2, and an external layer 4 enclosing the second internal layer 3. The first internal layer 2 comprises a pineapple filling; the second internal layer 3 comprises a vegetable/fruit filling; and the external layer 4 comprises mochi that is made of a rice-based material, such as glutinous rice, and is of a soft delicate form, wherein the second internal layer 3 is wrapped, with a predetermined thickness, around the first internal layer 2, and the external layer 4 is wrapped, with a predetermined thickness, around the second internal layer 3.

In the instant embodiment, the pineapple filling of the first internal layer 2 is a pineapple stuffing that includes, in a part thereof, fruit pulp and is of a sticky form.

In the instant embodiment, the vegetable/fruit filling of the second internal layer 3 is a vegetable/fruit stuffing made of banana, mango, coconut, or taro and is of a sticky form.

The mochi of the external layer 4, which is made of a rice-based material including glutinous rice and is of a soft delicate form is completely covered with steamed and sieved potato flour.

The above-mentioned food materials are combined to form a double-filling pineapple daifuku A, so that the double-filling pineapple daifuku A is provided with a compound flavor. Further, the combination of the pineapple filling of the first internal layer 2 with the vegetable/fruit filling of the second internal layer 3 provides the double-filling pineapple daifuku A with a new favor of two fillings when it is being eaten, thereby creating a soft and loose multilayered mouthfeel, providing the pineapple daifuku with better layer varying mouthfeel as compared with the traditional pineapple cakes to therefore greatly enhance the product value of daifuku.

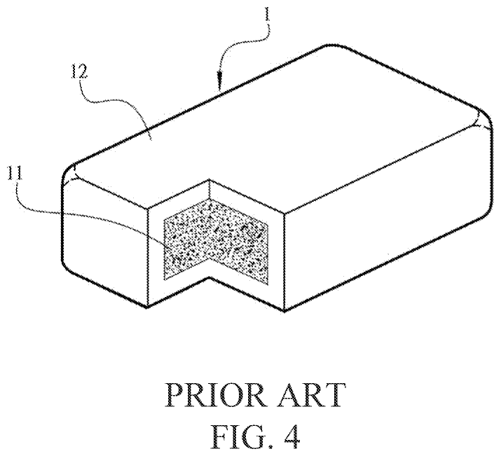

In the double-filling pineapple daifuku A according to the present invention, the external layer 4 is formed of mochi that is made of a rice-based material, such as glutinous rice, and is of a soft delicate form, so that the external layer 4 combined with the pineapple filling of the first internal layer 2 and the vegetable/fruit filling of the second internal layer 3 provides, in addition to the soft and delicate mouthfeel of mochi, a mouthfeel of double fillings of pineapple and vegetable/fruit and is different from the mouthfeel of the known pineapple cake 1 shown in FIG. 4 that is achieved with an outer pastry skin 12 in combination with a filling 11, so that it may be accepted by consumers who do not love the traditional favor of the known pineapple cake 1 to allow them to taste the flavor of the pineapple cake 1.

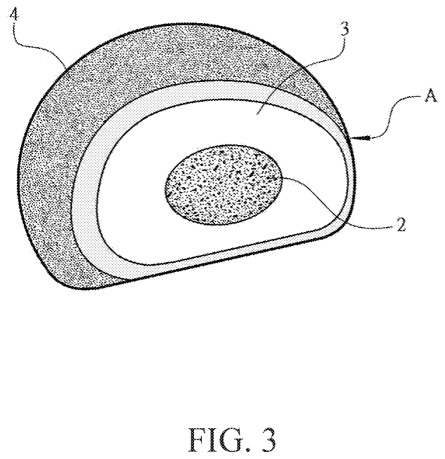

Referring to FIG. 3, which is a schematic view showing the present invention in a condition of being eaten, as shown in the drawing, a consumer, when purchasing and tasting the double-filling pineapple daifuku A, is placing the external layer 4, the second internal layer 3, and the first internal layer 2 all into the mouth at the same time so that after mochi of the external layer 4 and the vegetable/fruit filling of the second internal layer 3 are bitten open, the pineapple filling of the first internal layer 2, due to being a food material including, in a part thereof, fruit pulp and in a sticky form, is naturally exposed, so that when being eaten by the consumer, the vegetable/fruit filling of the second internal layer 3 that is in a sticky form is combined with the pineapple filling of the first internal layer 2 that is in a sticky form to generate a compound flavor and providing a unique new mouthfeel of double fillings, providing the double-filling pineapple daifuku A with a better layer varying mouthfeel as compared with the known pineapple cakes, thereby greatly enhancing the diet art of desserts.

Compared with the traditional dessert of pineapple cake, the present invention provides at least the following advantages:

(1) One single piece of double-filling pineapple daifuku A includes at least three food materials, including pineapple filling, vegetable/fruit filling, and rice-based material made mochi, and may enhance the diet art of desserts.

(2) One single piece of double-filling pineapple daifuku A provides a taste for stuffing of at least two flavors, and the stuffing includes the pineapple filling of the first internal layer 2 and the sticky vegetable/fruit filling of the second internal layer 3, providing a breakthrough to the flavor of the traditional daifuku and pineapple cake, and helping increasing the consumers' desire for purchases and increasing product sales.

(3) A composite flavor of pineapple in combination with various vegetable/fruit is presented, so that eating the double-filling pineapple daifuku A enables tasting a new flavor of mochi and pineapple in combination with various vegetable/fruit to thereby present a mouthfeel of double fillings, which is different from the traditional pineapple cakes.

(4) For consumers who do not love or do not accept the traditional flavor of the pineapple cakes, the present invention provides a choice of product that allows for tasting of pineapple cake flavor.

The above embodiment is provided as a best way of embodying the present invention and is not intended to limit the scope of the present invention. Minor modifications and variations that are not apart from the gist of the present invention are considered within the scope of the spirit of the present invention.

In summary, the present invention provides a double-filling pineapple daifuku that is formed of stuffing that is formed of pineapple in combination with various vegetable/fruit and an external layer formed of mochi. The pineapple filling and the vegetable/fruit filling of the internal layers, together with mochi of the external layer, create a soft and loose multilayered mouthfeel, presenting a new flavor of double fillings, providing the pineapple daifuku with better layer varying mouthfeel as compared with the known pineapple cakes, thereby enhancing the product value.

I claim:

1. A double-filling pineapple daifuku, comprising, in sequence from center to outside, a first internal layer, a second internal layer enclosing the first internal layer, and an external layer enclosing the second internal layer, wherein the first internal layer comprises a pineapple filling; the second internal layer comprises a vegetable/fruit filling; and the external layer comprises mochi formed of a soft and sticky rice-based material, and wherein the external layer is wrapped, with a predetermined thickness, around the second internal layer, such that when the double-filling pineapple daifuku is being eaten, the vegetable/fruit filling of the second internal layer and the pineapple filling of the first internal layer create a soft and loose multilayered mouthfeel, presenting a new flavor of double fillings.

2. The double-filling pineapple daifuku according to claim 1, wherein the pineapple filling of the first internal layer comprises a filling that includes, in a part thereof, fruit pulp and is of a sticky form.

3. The double-filling pineapple daifuku according to claim 1, wherein the vegetable/fruit filling of the second internal layer comprises a filling made of banana, mango, coconut, or taro.
